(19) United States
(12) Patent Application Publication
(10) Pub. No.: US 2008/0223534 A1
(43) Pub. Date: Sep. 18, 2008

(54) Sun protection blind for motor vehicle

(76) Inventor: Melf Hansen, Gondelsheim (DE)

Correspondence Address: FLYNN THIEL BOUTELL & TANIS, P.C., 2026 RAMBLING ROAD, KALAMAZOO, MI, 49008-1631, US

(21) Appl. No.: 12/075,369

(22) Filed: Mar. 11, 2008

(30) Foreign Application Priority Data
Mar. 12, 2007 (DE) 102007012259.6

(51) Int. Cl. B60J 1/20

(52) U.S. Cl. 160/370.22

(57) ABSTRACT

A sun protection blind for a window opening in a motor vehicle includes a winding shaft and a blind web, a first edge of which is fastened to the winding shaft. An extension profile is operatively connected to a second edge of the blind web so the blind web can be removed from the winding shaft by the extension profile, counter to a restoring force of a spring element. The blind web can be wound onto the winding shaft by means of the restoring force of the spring element, part of a spring motor having a shaft which is mounted so as to be able to rotate relative to the winding shaft. The spring element is arranged between the shaft and the winding shaft, and a rotational movement of the shaft is synchronized with a displacement of the extension profile during removal and/or winding of the blind web.

The invention relates to a sun protection blind for a window opening in a motor vehicle.

The sun protection blind is, for example, configured as a side window blind for a side window, as a rear window blind for a rear window and/or as a panoramic window blind for a panoramic window in a vehicle roof. The term “sun protection blind” is in this case used to describe any type of blind used to prevent infiltration of sunlight and/or to darken or at least cover the window opening. The sun protection blind can thus also act as a visor. A blind web is conventionally a knitted fabric. However, woven fabrics and/or plastics material films or the like can also be used as the blind web.

DE 101 58 428 A1 discloses a sun protection blind arrangement for motor vehicles comprising a rotatably mounted winding shaft, a blind web which can be wound onto the winding shaft or unwound therefrom, a traction rope arrangement or the like which acts on the free end of the blind web and is unwound from or wound onto a winding spool arrangement which is coaxial with the winding shaft, in the opposite direction to the direction in which the blind web is wound or unwound, and spring means for tensioning the composite system consisting of the winding shaft, blind web, traction rope arrangement and winding spool arrangement. Furthermore, the winding spool arrangement comprises a winding spool which is rotatable relative to the winding shaft, a torsion spring, which is prestressed by relative rotation of the winding spool arrangement and winding shaft with respect to each other in the sense of tensioning of the composite system, being arranged between the winding spool arrangement and the winding shaft. The blind web is wound and/or unwound by movement of a pulling hoop which connects a free end of the blind web to the traction ropes.

In other blind arrangements, what is known as a spring motor is provided for winding and tensioning the blind web. For example, EP 1 123 824 A2 discloses a sun protection blind, which is configured as a side window blind, for a side window opening in a motor vehicle comprising a winding shaft, a blind web, a first edge of which is fastened to the winding shaft, an extension profile which is operatively connected to a second edge of the blind web that opposes the first edge in such a way that the blind web can be removed from the winding shaft by means of the extension profile, and a drive device comprising a spring motor, wherein the spring motor has a spring element, the blind web can be removed from the winding shaft counter to a restoring force of the spring element and the blind web can be wound on by means of the restoring force of the spring element.

A necessary restoring force, and thus the size of a spring element to be used, is dependent inter alia on a maximum extension length of the blind web. The greater the necessary restoring force, the larger the overall space required for the sun protection blind. In addition, extension of a sun protection blind counter to a high restoring force can limit the convenience of a manual extension and/or require a more powerful drive motor for an automated drive, and this in turn increases the overall space required. However, in particular in the region of a side window, there is conventionally little overall space for attaching a side window blind.

The object of the invention is therefore to provide a particularly compact sun protection blind, in particular for covering a side window opening.

This object is achieved by a sun protection blind for a window opening in a motor vehicle, comprising a winding shaft, a blind web, a first edge of which is fastened to the winding shaft, an extension profile which is operatively connected to a second edge of the blind web that opposes the first edge, so the blind web can be removed from the winding shaft by means of the extension profile, and a drive device comprising a spring motor having a spring element, the spring motor comprising a shaft which is mounted so as to be able to rotate relative to the winding shaft, the spring element being arranged between the shaft of the spring motor and the winding shaft, and a rotational movement of the shaft being synchronized with a displacement of the extension profile during removal and/or winding of the blind web.

Synchronized joint rotation of the shaft allows a spring element to be provided with a lower restoring force than in the case of an identically configured blind in which the shaft remains stationary. If the extension profile is moved at a constant speed for unrolling the blind web, the shaft of the spring motor also rotates at a constant speed. The rotational speed of the winding shaft, on the other hand, rises owing to the decreasing winding diameter of the blind web on the winding shaft during unwinding of the blind web. The spring element preserves sufficient tension in the blind web, although the rotation of the shaft of the spring motor prevents opposing forces for unwinding from becoming too great. During winding of the blind web onto the winding shaft, the rotational speed of the winding shaft, which drops as the winding diameter of the blind web on the winding shaft rises, allows the shaft of the spring motor to advance ahead of the winding shaft. As a result, the spring element is tensioned in such a way that a force required for winding the blind web is applied.

In one embodiment of the invention, the drive device comprises an electric motor, in particular a geared motor. A motor of this type easily allows remote-controlled driving, for example by a driver and/or a user. In other embodiments, the extension profile can be displaced manually, pneumatically and/or hydraulically, suitable coupling means being provided in order to synchronize a movement of the extension profile with the rotational movement of the shaft of the spring motor.

In a development of the invention, synchronization is carried out by means of a rope and/or belt drive. A belt drive can, for example, be configured as a toothed belt drive, the belt drive being driven by means of a gear-wheel.

In a development of the invention, the rope and/or belt drive comprises an endless rope or an endless belt. The extension profile is in one embodiment attached to the endless rope or the endless belt at a suitable position. The belt and/or the rope also drives the shaft of the spring motor via a frictional force and/or via an interlocking fit, for example via a toothed belt.

In one embodiment of the invention, a drive shaft of the electric motor is arranged parallel to the shaft of the spring motor, the distance between the drive shaft and the shaft of the spring motor being greater than or equal to a maximum extension length. In the case of an endless belt or an endless rope, the shaft of the spring motor also acts in this case as a return roller for the rope or belt drive. The shaft can have a diameter which is suitable for the movement and/or be configured with a flange or the like for a movement entry.

In a further embodiment, the drive device comprises at least one deflection roller. This allows the drive motor to be arranged at a suitable position in the motor vehicle.

In a further embodiment, the drive device comprises a pressure-stiff, flexible, elongate element and/or a toothed rack, wherein the extension profile and the shaft can be driven by means of the pressure-stiff, flexible element and/or the toothed rack. The pressure-stiff, flexible element is, for example, a flexible plastics material and/or metal wire, a core of a Bowden cable, a stranded wire strand or a toothed cord. The flexible element can be stowed within the vehicle door in a space-efficient manner, for example so as to be able to be rolled on a shaft. The term “toothed cord” refers in the sense of the invention to a flexible force transmission means which, compared to its thickness, is very elongate and by means of which both tensile and compressive forces can be transmitted. A toothed cord comprises, for example, a flexurally resilient core which is conventionally cylindrical in its configuration and a spiral which is wound around the core in order thus to form oblique teeth. The toothed cord is sufficiently rigid in order to displace the extension profile of the sun protection blind, especially if the toothed cord is guided in a guide.

In a further embodiment of the invention, the drive shaft is arranged coaxially with the shaft of the spring motor. The shaft can in this case be driven directly via the drive motor. Movement is transmitted to the extension profile, for example, by means of a rope and/or belt drive and/or by means of a toothed rack or the like.

In a further embodiment of the invention, the sun protection blind is configured as a side window blind, the winding shaft being arranged parallel to a lateral edge of a window opening. Especially if the winding shaft is arranged horizontally, there is conventionally little overall space in the axial direction of the winding shaft. The rotatable mounting according to the invention of the spring motor allows a large restoring spring to be dispensed with, thus greatly reducing the amount of space required.

In a further embodiment of the invention, the blank of the blind web corresponds at least approximately to a shape of a window opening in a side window. This allows effective darkening and/or effective protection from the sun to be achieved.

Further advantages of the invention will emerge from the subsequent description of exemplary embodiments of the invention that are illustrated schematically in the drawings. The drawings use like reference numerals for identical or similar components. All of the features and/or advantages emerging from the claims, the description or the drawings, including method steps, design details and spatial arrangements, may be instrumental to the invention both in isolation and in a broad range of combinations. Features which are described or illustrated as part of one exemplary embodiment can also be used in another exemplary embodiment in order to obtain a further embodiment of the invention.

In the drawings:

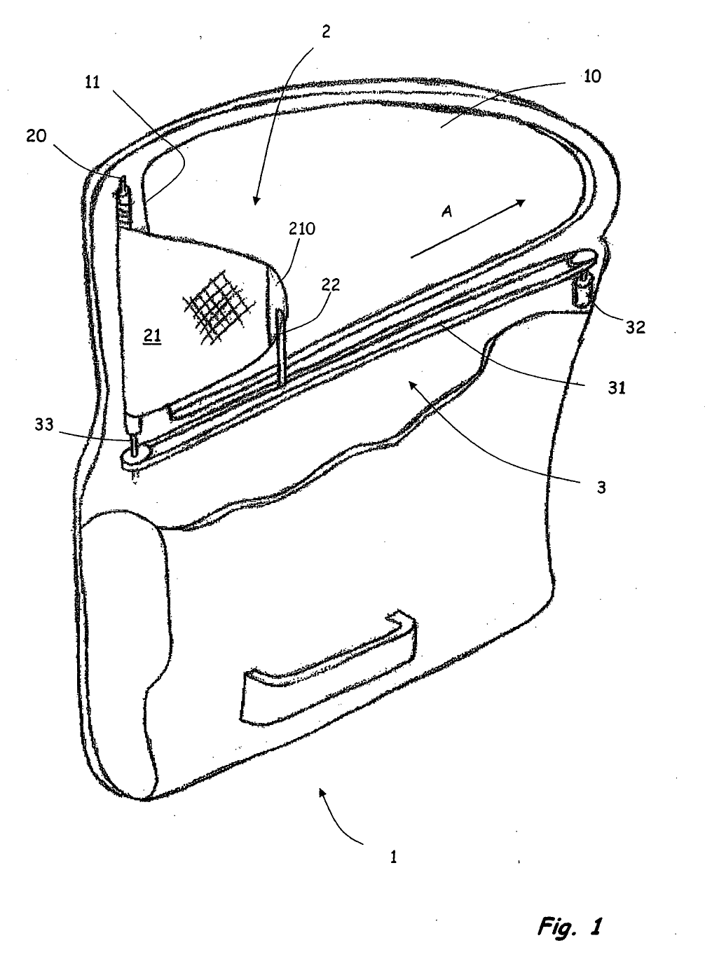

FIG. 1 is a partially cut-away view of a rear, right-hand side door of a motor vehicle comprising a side window blind according to the invention;

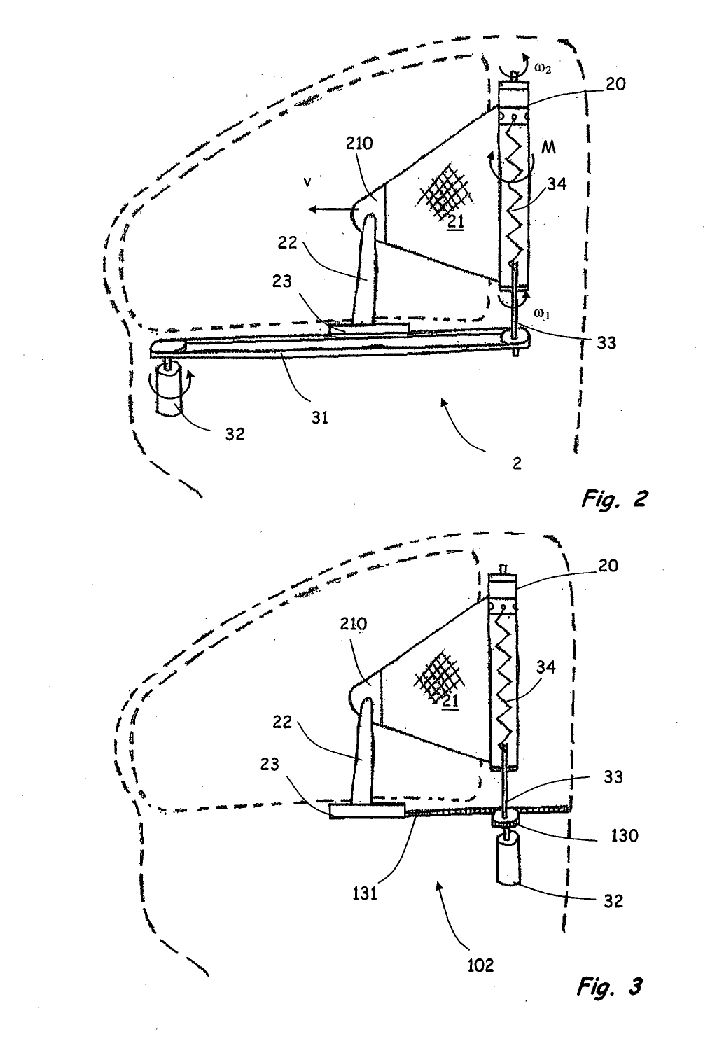

FIG. 2 is a partially cut-away view of a side window blind according to FIG. 1;

FIG. 3 is a partially cut-away view of a second exemplary embodiment of a side window blind according to the invention; and

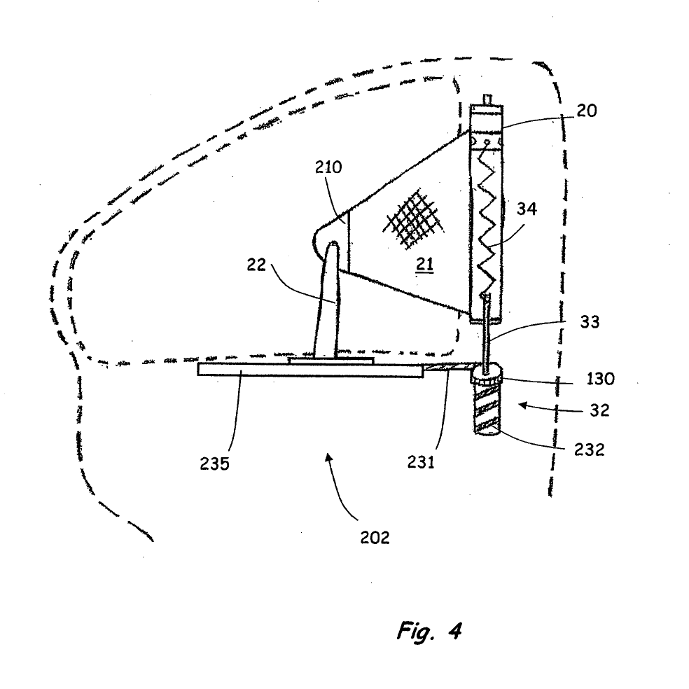

FIG. 4 is a partially cut-away view of a third exemplary embodiment of a side window blind according to the invention.

FIG. 1 shows schematically a rear right-hand side door 1 of a motor vehicle, on which a sun protection blind according to the invention, which is configured as a side window blind 2, is arranged. The side door 1 has a window opening 10 which can be covered by the side window blind 2. The window opening 10 has a front edge 11, a winding shaft 20 of the illustrated side window blind 2 being arranged parallel to the edge 11 of the side window opening 10.

The side window blind 2 comprises a blind web 21, a first edge (not shown) of which is fastened to the winding shaft 20. The blind web 21 is, for example, a woven fabric, knitted fabric, a plastics material film or the like which is configured so as to be impervious to visible light and/or UV light.

The side window blind 2 further comprises an extension profile 22 which is operatively connected to a second edge 210 of the blind web 21 that opposes the first edge, thus allowing the blind web 21 to be removed from the winding shaft 20 by means of the extension profile 22. A drive device 3 of the side window blind 2 has a spring motor comprising a spring element (not shown in FIG. 1) which is arranged in the winding shaft 20. The blind web 21 can be unwound, counter to a restoring force of the spring element (not shown), from the winding shaft 20 by displacement of the extension profile 22 in an extension direction A. The blind web 21 is wound onto the winding shaft 20 by means of a restoring force of the spring element.

The extension profile 22 is displaced in the first exemplary embodiment, illustrated in FIG. 1, by means of a belt drive comprising an endless belt 31. The endless belt 31 is driven via an electric geared motor 32. The extension profile 22 is attached to the belt 31, for example bonded and/or riveted thereto.

According to the invention, the spring motor 30 has a shaft 33 which is mounted so as to be able to rotate relative to the winding shaft 20, the shaft 33 also being driven by the endless belt 31, so a rotational movement of the shaft 33 is synchronized with a translatory movement of the extension profile 22.

FIG. 2 is a schematic, partially cut-away view of the side window blind 2 according to FIG. 1, a contour of the side door 1 according to FIG. 1 being indicated by broken lines to improve understanding. FIG. 2 is a cut-away view of the winding shaft 20, showing a spring element 34 of the spring motor. As may be seen in FIG. 2, the spring element 34 is arranged between the winding shaft 20 and the shaft 33 of the spring motor 30, the ends of the spring element 34 being connected, for example, to the shaft 33 or the winding shaft 20 for the transmission of movement. For removing the blind web 21 from the winding shaft 20, the belt 31 is driven anticlockwise in the embodiment illustrated in FIG. 2. The movement of the belt 31 is transmitted to the shaft 33, so the shaft 33 rotates at a rotational speed ω₁. A displacement of the extension profile 22 at a speed v causes driving of the winding shaft 20 at a rotational speed ω₂ for unrolling the blind web 21. As the blind web 21 is removed, a winding diameter of the blind web 21 on the winding shaft 20 decreases. As the winding diameter on the winding shaft 20 decreases, the rotational speed of the winding shaft 20 rises during removal. If the rotational speed ω₂ of the winding shaft 20 exceeds a rotational speed ω₁ of the shaft 33, the spring element 34 is tensioned. The tensioning of the spring element 34 causes the exertion of a restoring moment M which is indicated schematically by an arrow and by means of which the blind web 21 is held in a tensioned state. Reversal of the direction of rotation of the drive motor 32 causes the blind web 21 to roll onto the winding shaft 20. The movement of the shaft 33 can in this case advance ahead of the movement of the winding shaft 20. Tensioning resulting therefrom of the spring element 34 also causes a moment M for tensioning the blind web 21. The extension profile 22 shown is gallows-shaped, the extension profile 22 being fastened to the belt 31 via a carriage 23. The carriage 23 can in this case be displaceably mounted in a guide (not shown).

FIG. 3 shows a second exemplary embodiment of a sun protection blind 102 according to the invention. The sun protection blind 102 corresponds substantially to the sun protection blind 2 according to FIG. 2 and like reference numerals are used for identical components. These components will not be described in detail. In the sun protection blind 102, a drive motor 32 is arranged coaxially with the shaft 33 of the spring motor 30. A drive shaft of the drive motor 32 can in this case be formed in one piece with the shaft 33. A gear-wheel 130, which can be used to drive a toothed rack 131, is arranged on the shaft 33. The toothed rack 131 is operatively connected to the extension profile 22, so the extension profile 22 can be displaced by means of the toothed rack 131. The toothed rack 131 and/or the carriage 23 can in this case be displaceably mounted in a guide (not shown) and thus be guided.

FIG. 4 shows a side window blind 202 according to a third exemplary embodiment of the invention. The side window blind 202 corresponds substantially to the side window blind 102 according to FIG. 3 and like reference numerals are used for identical components. These components will not be described. In the exemplary embodiment according to FIG. 4, the shaft 33 and the extension profile 22 are driven by means of a toothed cord 231. In the illustrated exemplary embodiment, the toothed cord 231 can be wound on a shaft 232 which is arranged coaxially with the drive motor 32. The toothed cord 231 and the carriage 23 are displaceably mounted in a guide 235 in order thus to prevent buckling of the toothed cord 231.

A compact configuration according to the invention is particularly advantageous for the illustrated side window blinds comprising horizontally arranged winding shafts. However, a sun protection blind according to the invention can be arranged also on a panoramic window and/or a rear window of a motor vehicle.

1. Sun protection blind for a window opening in a motor vehicle, in particular a side window blind, comprising a winding shaft a blind web, a first edge of which is fastened to the winding shaft, an extension profile which is operatively connected to a second edge of the blind web that opposes the first edge, so the blind web can be removed from the winding shaft by means of the extension profile, and a drive device comprising a spring motor, wherein the spring motor has at least one spring element, the blind web can be removed from the winding shaft counter to a restoring force of the spring element and the blind web can be wound onto the winding shaft by means of the restoring force of the spring element, wherein the spring motor has a shaft which is mounted so as to be able to rotate relative to the winding shaft, the spring element being arranged between the shaft and the winding shaft, and a rotational movement of the shaft being synchronized with a displacement of the extension profile during removal and/or winding of the blind web.

2. Sun protection blind according to claim 1, wherein the drive device comprises a drive motor.

3. Sun protection blind according to claim 2, wherein synchronization is carried out by means of a rope and/or belt drive.

4. Sun protection blind according to claim 3, wherein the rope and/or belt drive comprises an endless rope or an endless belt.

5. Sun protection blind according to claim 3, wherein a drive shaft of the drive motor is arranged parallel to the shaft of the spring motor, the distance between the drive shaft and the shaft of the spring motor being greater than or equal to a maximum extension length.

6. Sun protection blind according to claim 3, wherein the drive device comprises at least one deflection roller.

7. Sun protection blind according to claim 1, wherein the drive device comprises a pressure-stiff, flexible element and/or a toothed rack, wherein the extension profile and the shaft can be driven by means of the pressure-stiff, flexible element and/or the toothed rack.

8. Sun protection blind according to claim 6, wherein the drive shaft of the drive motor is arranged coaxially with the shaft of the spring motor.

9. Sun protection blind according to claim 1, wherein the sun protection blind is configured as a side window blind, the winding shaft being arranged parallel to a lateral edge of a window opening.

10. Sun protection blind according to claim 1, wherein a blank of the blind web corresponds at least approximately to a shape of a window opening in a side window.

11. Sun protection blind according to claim 2, wherein the drive motor comprises an electric motor.

12. Sun protection blind according to claim 11, wherein the drive motor further comprises a geared motor.
